(19) United States
(12) Patent Application Publication
(10) Pub. No.: US 2005/0104441 A1
(43) Pub. Date: May 19, 2005

(54) Fiber reinforced composite wheels

(76) Inventor: Peter C. Bertelson, Sedona, AZ (US)

Correspondence Address: BARNES & THORNBURG, P.O. BOX 2786, CHICAGO, IL, 60690-2786, US

(21) Appl. No.: 10/992,160

(22) Filed: Nov. 18, 2004

Related U.S. Application Data
(60) Provisional application No. 60/523,884, filed on Nov. 19, 2003.

(51) Int. Cl. B60B 5/02

(52) U.S. Cl. 301/64.703

(57) ABSTRACT

A fiber reinforced truck wheel and practical methods of making a fiber-reinforced truck wheel. The fiber-reinforced truck wheel is produced by spiral winding a suitable fiber cloth to form a rim-charge and curing the rim-charge and a disc-charge in a mold.

### RELATED APPLICATION

This application claims priority to U.S. Ser. No. 60/523,884 filed Nov. 19, 2003.

### FIELD

This application generally relates to one-piece composite car and truck wheels that are light-weight and durable.

### BACKGROUND

Wheels for automobiles, trucks, motorcycles, aircraft, and other objects such as pulleys require greater strength to operate under various loads and also to be of lighter weight for conserving energy and for reducing the tare weight of commercial vehicles.

One of the primary functions of fibers or reinforcements for plastic is to shoulder the load along the length of the fiber, to improve strength and stiffness of resin in one direction. Some of the commercial reinforcing materials include glass fiber, cotton, Kevlar, carbon, and basalt. Many reinforcements for thermosetting or thermoplastic resins get some form of surface treatment or other material such as resinous binders to hold fibers together in bundles, to act as lubricants, to protect fibers from degradation and to bond with the surrounding resins. Glass fibers used for reinforcing composites generally range in diameter from 0.00035″ to 0.00090″ (9 to 23 microns). Carbon fibers created using polyacrylonitrile (PAN), pitch or rayon fiber precursors offer good strength and modulus values up to 85-90 Msi and good compression strength for structural applications up to 1000 ksi.

Composite structures made of plastic resin or fiberglass are often reinforced with fibers for increased strength. Attempts have been made to develop wheels that have adequate strength and lighter weight, but without much commercial success, in part, due to expensive manufacturing and higher capital investment. For example, U.S. Pat. No. 4,749,235 to McDougal describes a Thyssen-Budd scheme, later canceled, for making a wheel rim from layers of unidirectional cloth. Other examples that describe composite wheels include JP Pat. No. 89-102287/14 to Kenai, U.S. Pat. No. 4,294,490 to Woelfel, U.S. Pat. No. 4,462,946 to Goldsworthy, and U.S. Pat. No. 4,532,097 to Daniels. Despite these developments, reinforced composite wheels have not been adopted for wide-spread use in automobiles or trucks.

U.S. Pat. No. 5,073,315 to Bertelson, a common assignee, discloses methods to make fiber reinforced wheels. The disclosure of this patent is incorporated by reference as if fully set forth herein.

Composite wheels with fiber-reinforcements that have greater strength and that do not require expensive manufacturing processes are desirable.

### SUMMARY OF THE INVENTION

This disclosure relates to manufacturing fiber-reinforced composite wheel rims with biased cloth or resin-impregnated biased cloth that is spiral wound. The spiral-wound resin impregnated biased cloth in a rim-charge is cured under pressure in a mold under a suitable temperature to form the wheel rim. The disc-charge includes an array of sheet molding compound or bulk molding compound molded to form a composite wheel. A fiber reinforced resin article includes structures such as an automobile or truck wheel and pulleys.

### BRIEF DESCRIPTION OF THE DRAWINGS

The drawings are provided to illustrate some of the embodiments of the disclosure. It is envisioned that alternate configurations of the embodiments of the present disclosure may be adopted as illustrated in these drawings.

FIG. 1 is a sectional view of a truck wheel taken along line 1-1 of FIG. 2;

FIG. 2 is a partial-front view of the truck wheel in FIG. 1;

FIG. 3 is an illustration showing a loose weave fiber cloth cut along the line A-B-C-D;

FIG. 4 shows a biaxial crossed weft cloth or two layers of unidirectional cloth superimposed;

FIG. 5 is a schematic illustration for manufacturing a rim-charge and a disc-charge; and

FIG. 6 shows a cross-section of a wheel mold in the open position and in the closed position to manufacture a wheel.

### DETAILED DESCRIPTION

While the present disclosure may be susceptible to embodiments in different forms, there are shown in the drawings, and herein will be described in detail, embodiments with the understanding that the present description is to be considered an exemplification of the principles of the disclosure and is not intended to be exhaustive or to limit the disclosure to the details of construction and the arrangements of components set forth in the following description or illustrated in the drawings.

Methods to manufacture fiber reinforced composite wheels, such as, for example, truck wheels in an economic, efficient, and simplified manner are disclosed. The processes include fabricating a rim charge, a disc charge and then integrating the rim charge and the disc charge to develop a wheel structure. The wheel structure is developed using a conventional compression molding or resin transfer molding or any other suitable molding that is practiced in the art.

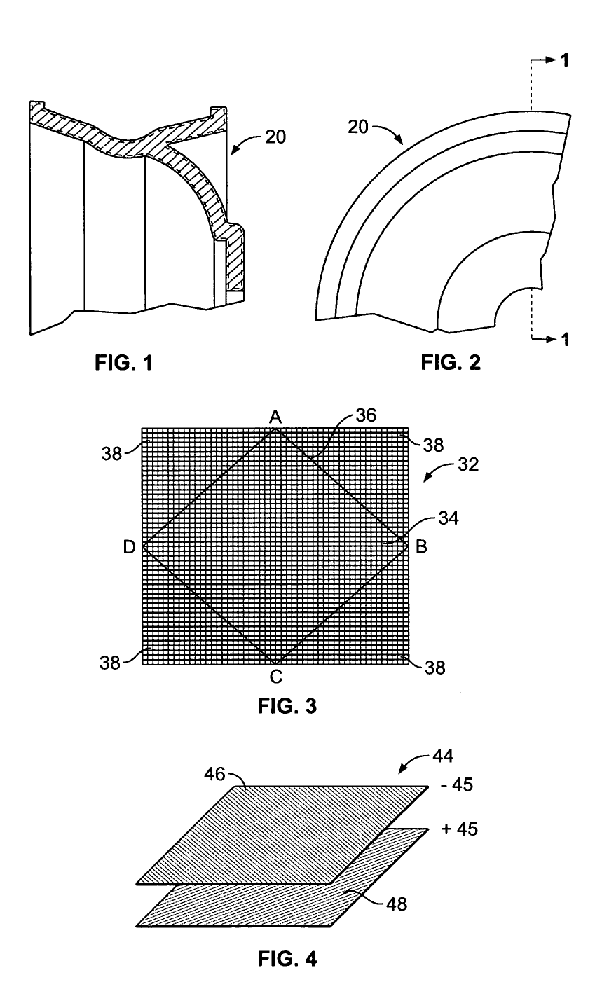

FIGS. 1 and 2 generally refer to a representative truck wheel 20, manufactured in accordance with the present disclosure. The truck wheel 20 is made of fiber reinforced resin such as fiberglass-epoxy or basalt-fiber epoxy reinforced resin. Generally, as used herein, “composite wheels”, “fiber reinforced wheels”, “fiber reinforced composite wheels”, “reinforced wheels”, all refer to wheel structures that include one or more fiber reinforcements. The wheel 20 is stronger and stiffer in the direction needed to react to the radial and cornering loads, and the wheel 20 can be made with less total material—to reduce the cost of the wheel, reduce weight, and decrease the curing time in a mold. FIG. 3 illustrates how a loose weave cloth 32 can be cut along the lines A-B-C-D (36), discarding the corners 38. The fibers 34 in the cloth 32 comprise a loose weave and provide an effective reinforcement for a molded wheel structure such as, for example, wheel a rim, when edges AD and BC are oriented parallel to the wheel axis. FIG. 4 shows a biaxial crossed weft cloth or two layers of unidirectional cloth 44 superimposed, wherein the direction of fibers initially at angle of approximately −45° (46) and +45° (48) shift during winding so that the cloth for a rim-charge conforms to the necessary drop-center profile of FIG. 1.

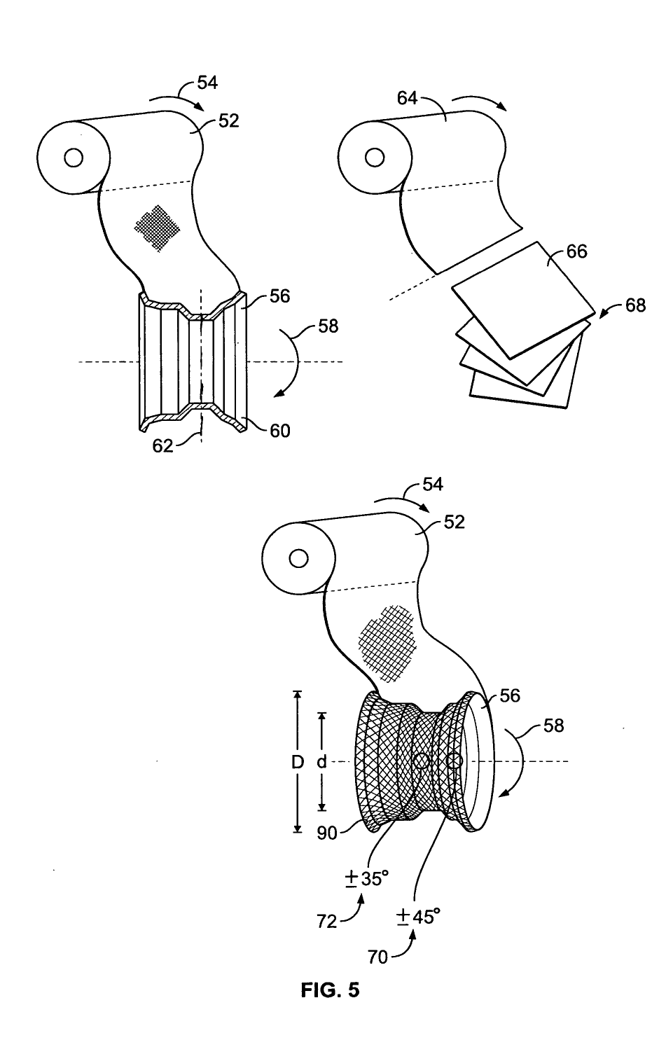

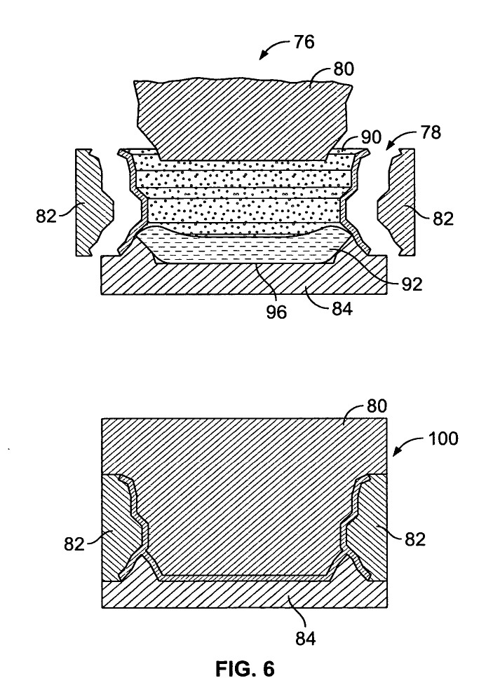

A schematic illustration to produce a wheel 20 that includes a rim-charge 90 and a disc-charge 92 is shown in FIGS. 5 and 6. In an embodiment as shown in FIG. 5, top left panel, a spool of biased cloth 52 (either a unidirectional biased cloth 44 or a loose weave biased cloth 32) is spiral-wound around a rim-like fixture 56. The rim-like fixture 56 may be a pre-molded rim, structurally modified along its diameter 60 to accommodate extra layers of fiber cloth 52 that are spiral-wound to form the rim-charge 90. The fixture 56 is separable at its smallest diameter 62 so that the rim-charge 90 can be removed from the fixture 56.

The fiber cloth 52 may be pre-impregnated with resin or used as a dry fiber cloth. The fiber cloth 52 is spiral-wound around the fixture 56 by rotating the fixture 56 along the axis of rotation 58 in conjunction with a synchronized spinning of the spool of cloth 52 along its axis of rotation 54. In FIG. 5, a schematic illustration of the rim-charge 90 with the alignment of fibers is shown in the bottom panel. In the illustrated embodiment, a single layer of a fiber cloth 52, at angle of −45° to the axis of the wheel 20, is spirally wound around the fixture 56. As the diameter of the rim-charge decreases, the −45° angle (70) shifts to approximately −350 angle (72). For example, the squares (α=+45°) 70 near the maximum diameter of the rim-charge 90 become rhomboidal or diamond-shaped 72, when the loose-weave biased cloth 52 is pulled in a tangential direction. The angle (a) of the fibers at a smaller diameter section of the rim-charge 90 decreases proportionally, according to the following equation: α=tan⁻¹(d/D); wherein a is the angle of the fibers at a particular location in the rim-charge 90; d is the local diameter of the rim-charge 90; and D is the maximum diameter of the rim-charge 90. As the diameter of the rim-charge 90 changes, a single, straight fiber is deflected to a very slight ‘S’ shape, if viewed from the top.

The winding of the fiber cloth 52 continues until a desired thickness is reached, such as, for example, of about 0.25 inch to about 0.50 inch. The thickness depends upon the nature of the fibers, orientation of the fibers, the size and shape of the wheel, the anticipated load, cost, and weight of the wheel. The finished rim-charge 90 may be slightly smaller than the desired size and shape of the rim of the wheel 20 to align fibers in the mold 76 to allow for easy closing of the mold 76 prior to curing. The rim-charge 90 resembles the hour-glass contour of the fixture 56 shown in FIG. 5. A suitable width for a rim-charge 90 is about 10 inches for a wheel that is about 22 inches in diameter.

In the embodiment of FIG. 5 top right panel and FIG. 6, a disc-charge 92 is produced by cutting sheets of sheet molding compound (SMC) 66 to form a stack or an array 68 of SMC sheets. Bulk molding compound (BMC) can also be used to form a similar array 68. The disc-charge 92 is produced by first cutting SMC 66 sheets into squares that are approximately 20 inches on an edge. These SMC 66 squares are arranged to create a staggered array 68 of suitable thickness. The array 68 of SMC sheets 66 or BMC is arranged to fit the mold 76.

A schematic illustration of the mold 76 in an open 78 position and in a closed 100 position is shown in FIG. 6. The mold 76 includes a top punch member 80, two side members or slides 82 and a bottom member or a base 84. The disc-charge 92 is placed on the top surface 96 of the bottom member 84. Then, the rim-charge 90 is removed from the fixture 56 and is placed in the mold 76 in the open 78 position. The rim-charge 90 and the disc-charge 92 may be pre-heated to a desired temperature. After the disc-charge 92 and the rim-charge 90 are placed in the mold 76, additional resin or fibers are added to the center of the mold 76 if necessary. Then, the two side members 82 and the top member 80 are closed to form the closed position 100 of the mold 76.

The rim-charge 90 and the disc-charge 92 along with any additional fibers or resins in the mold 76 are heated to a range of about 100° F. to 300° F. for a suitable amount of time, such as for example 5 min to 30 min. Suitable pressure, in the range of about 1000-2000 psi may also be used to remove air and to mold the wheel 20. The rim-charge 90 and the disc-charge 92 are integrated to form the wheel 20. The molding of the rim-charge 90 and the disc-charge 92 to manufacture a wheel 20 as described herein generally refers to “compression molding”. Methods to internally heat a mold are disclosed in U.S. Pat. No. 5,073,315 to Bertelson, a common assignee. The disclosure of this patent is incorporated by reference as if fully set forth herein. Other types of molding, such as, for example, “resin-transfer molding” (RTM) can also be used to produce the fiber reinforced wheel 20 of this disclosure. RTM, also referred to as “liquid molding” involves a process, wherein dry fiber reinforcement—a preform—is placed into a composite or metallic mold and the mold is then closed. Resin and catalyst, measured and mixed in dispenser-equipment, are then pumped into the mold under pressure through injection ports or inlet channels. The resin and the catalyst follow pre-determined paths and generally permeate through the preform. Low-viscosity resin is preferred in RTM applications to permeate preforms quickly and evenly before curing takes place. Both mold and resin can be preheated if necessary. Many RTM applications use two-part epoxy formulations that are mixed before they are injected into the mold. Depending upon the need for short cycle times, either compression molding or RTM can be used to manufacture the wheel 20 of this disclosure.

The steps described herein to produce the rim-charge 90 and the disc-charge 92 for the wheel 20 represent inexpensive and simpler ways to manufacture fiber reinforced wheel structures. The methods described herein also obviate the need for expensive braiding or complicated circumferential threading of fibers. The methods described herein use readily available SMC sheets or BMC, resin-impregnated cloth or unimpregnated dry fiber, cloth that is loosely woven or unidirectional unwoven, and resins.

In an embodiment, the processes disclosed herein are also suitable to manufacture a fiber reinforced composite wide-single truck wheel with approximately usual double-load capacity. The fiber reinforced composite truck wheels manufactured according to the disclosure herein may withstand sufficient vertical load of approximately 90 KN/20,000 lbf-lb of force) for many thousand miles or many million revolutions. The composite wheel is also capable of handling the diverse loads encountered during braking, cornering, and impacting. The wheel 20 may weigh in the range of 35-40 lb for truck wheels and 10-20 lb for automobile wheels.

In an embodiment, a rim-charge 90 is designed and manufactured by spiral winding a cloth impregnated resin sheet, wherein the desired cloth is biased woven or unwoven, and wherein the fibers are aligned at an angle, such as, for example 45° to the axis of the wheel. Other suitable angles include 150, 300, 600, and 750 in the “plus (+)” and “minus (−)” direction. When the resin impregnated cloth is wound to create the rim-charge 90, the direction of fibers with respect to the axis of the wheel, increases somewhat longitudinal towards the drop-center direction. In other words, the length of the fibers is oriented towards the drop-center profile of the rim-charge 90. This allows the rim-charge 90 with the fibers to adapt to the variable diameter contour of the wheel and not merely wrap as a cylinder. In an embodiment, rim-winding of the impregnated fibers (e.g., biased cloth) can be combined with sheet molding compound (SMC) or bulk molding compound (BMC) and the entire process may be automated.

A suitable average fiber volume in a composite wheel structure is about 40% to about 70%. The wheel rim or the rim-charge 90 may have a slightly higher or lower fiber volume than the wheel disc or the disc-charge 92. The ideal fiber volume depends on factors such as economics, desired mechanical properties, contour of the wheel, nature and orientation of the fibers, and molding conditions.

Suitable fabrics or fiber cloth for the manufacture of a wheel structure may include stitch bonded fabrics or fibers that provide flexibility and strength relative to fabrics that are woven. Vectorply Corp. (Phenix City, Ala., U.S.A.) offers +45°/−45° stitched fabrics and a variety of other weaves. V2 Composite Reinforcements (Auburn, Ala., U.S.A.) offers V-Lock stitch technology to produce multiaxial fabrics including tubular stitched fabrics.

Common fiber cloths are constructed of glass, carbon, aramid, Kevlar, and basalt fibers. These fabrics are available in several weave constructions and thickness (from 0.0010 to 0.40 inches). Fiber cloth is typically supplied on rolls of 25 to 300 yards in length and about 1 to 120 inches in width. A suitable fabric or fiber cloth, for use in the manufacture of a wheel structure 20 disclosed herein, may be stable enough to be handled, cut and transported to the mold, and yet flexible enough to conform to the shape of the desired wheel structure. Fabrics or fiber cloth, including but not limited to biased, unbiased, woven, non-woven, non-crimped, braided, non-braided, and stitch bonded, allow use as reinforcement. For example, in an embodiment disclosed herein, the fabric impregnated with a suitable resin can be spiral wound to generate an hour-glass contour for the rim-charge 90.

Prepregs include a fiber-reinforcement form and a polymer matrix that are ready to be molded to a desired structure. A prepreg is generally prepared by passing reinforcing fibers or forms such as fabrics through a resin bath. The resin is bonded (impregnated) to the fiber and then heated to advance the curing reaction to different curing stages (“B-stage prepreg”). Thermoset or thermoplastic prepregs are suitable for manufacturing wheel structures disclosed herein and can be stored either in a refrigerator or at room temperature depending on the constituent materials. Prepregs can be manually or mechanically applied depending on the design requirements.

Thermoset resins including but not limited to polyester, vinyl ester, and phenolic resin and other exemplary resins are suitable to manufacture a wheel according to the present disclosure.

Release agents facilitate removal of wheel structures from molds. These products can be added to the resin, applied to molds, or both. Zinc stearate is a common mold release agent that is mixed into resin for compression molding. Waxes, silicones and other release agents may be applied directly to the surface of molds.

The materials and methods disclosed herein are also applicable to other molded products such as, for example, a pulley that is symmetrical or partially symmetrical about an axis. Any other structures that are symmetric or partially symmetric about an axis can be manufactured according to the present disclosure.

1. A method of making a fiber reinforced resin article comprising oriented reinforcing fibers, the method comprising the steps of:
(a) preparing a rim-charge comprising orienting the reinforcing fibers in a specified direction by spiral winding a biased fiber cloth along an axis to a desired shape;
(b) preparing a disc-charge comprising a fiber reinforced molding compound;
(c) placing the disc-charge and the rim-charge in a mold;
(d) curing the rim-charge and the disc-charge in the mold to form the article; and
(e) removing the article from the mold.

2. The method of claim 1, wherein the fiber reinforced resin article is an automobile or truck wheel.

3. The method of claim 2, wherein the fiber cloth comprises fibers oriented approximately in a ±45° direction with respect to the axis of a wheel.

4. The method of claim 2, wherein the fiber cloth comprises fibers oriented in a direction ranging from about ±15° to about ±60° with respect to the axis.

5. The method of claim 1, wherein the fiber cloth is a resin pre-impregnated fiber cloth.

6. The method of claim 1, wherein the molding compound is selected from the group consisting of sheet molding compound and bulk molding compound.

7. The method of claim 1, wherein temperature of the mold is about 100° F. to 300° F.

8. The method of claim 1, wherein the curing is carried out through a compression molding process.

9. The method of claim 1, wherein the rim-charge is further prepared by adding one or more layers of sheet molding compound or bulk molding compound to the fiber cloth during spiral winding.

10. The method of claim 1, wherein the curing is carried out through a resin-transfer molding process, wherein the fiber cloth is impregnated with resin during the resin-transfer molding.

11. The method of claim 1 further comprising placing additional resin and fiber in the mold prior to the curing.

12. The method of claim 1, wherein the curing is performed by ultra-violet light treatment or by electromagenetic radiation treatment.

13. The method of claim 1, wherein the curing is performed at room temperature.

14. A method of making a fiber reinforced composite truck wheel comprising oriented reinforcing fibers, the method comprising:
(a) preparing a rim-charge comprising orienting the reinforcing fibers in a specified direction by spiral winding a biased fiber cloth along an axis to resemble a wheel rim;
(b) preparing a disc-charge comprising sheet molding compound or bulk molding compound;
(c) placing the rim-charge, the disc-charge, and resin in a mold;
(d) curing the rim-charge, the disc-charge, and the resin in the mold to form the wheel; and
(e) removing the wheel from the mold.

15. The method of claim 14, wherein the truck wheel is a wide-single truck wheel with approximately double usual load capacity.

16. The method of claim 1, wherein the fiber cloth is constructed with fibers selected from the group consisting of glass, cotton, carbon, aramid, Kevlar, and basalt fibers.

17. The method of claim 1, wherein the fiber reinforced resin article is a pulley.

18. A composite drop-center wheel comprising a rim, the rim comprising spiral-wound biased fiber cloth along an axis of the wheel wherein the fibers are oriented in a specified direction and impregnated with resin.

19. The composite wheel of claim 18, wherein the fibers are oriented in a direction ranging from about ±15° to about ±60° with respect to the wheel axis.

20. The composite wheel of claim 18 further comprising a wheel disc, the wheel disc comprises sheet molding compound or bulk molding compound.

21. The composite wheel of claim 18, wherein the rim comprises resin pre-impregnated fiber cloth and one or more layers of fiber reinforced molding compound.
